(19) United States
(12) Patent Application Publication
(10) Pub. No.: US 2024/0217107 A1
(43) Pub. Date: Jul. 4, 2024

(54) METHOD AND SYSTEM FOR CONTROLLING A TELEROBOTIC ROBOT

(71) Applicant: KUKA Deutschland GmbH, Augsburg (DE)

(72) Inventor: Juan David Munoz Osorio, Augsburg (DE)

(73) Assignee: KUKA Deutschland GmbH, Augsburg (DE)

(21) Appl. No.: 18/558,436

(22) PCT Filed: Apr. 22, 2022
(86) PCT No.: PCT/EP2022/060748

§ 371 Date: Nov. 1, 2023

(30) Foreign Application Priority Data
May 4, 2021 (DE) 10 2021 204 495.6

(51) Int. Cl. B25J 9/16

(52) U.S. Cl. CPC B25J 9/1689

(57) ABSTRACT

A method for controlling a telerobotic robot using an input device which has a movable actuator includes repeatedly:
commanding a target pose of the telerobotic robot on the basis of a detected position of the actuator; and
commanding a target force of the actuator;
   wherein at least one virtual border is specified between a permissible and an impermissible region for the telerobotic robot, and the target force includes a restoring force component starting from said border, the restoring force component counteracting an actuation of the actuator for commanding a movement of the telerobotic robot away from the border in the direction of the impermissible region.

### CROSS-REFERENCE TO RELATED APPLICATIONS

This application is a national phase application under 35 U.S.C. § 371 of International Patent Application No. PCT/EP2022/060748, filed Apr. 22, 2022 (pending), which claims the benefit of priority to German Patent Application No. DE 10 2021 204 495.6, filed May 4, 2021, the disclosures of which are incorporated by reference herein in their entirety.

### TECHNICAL FIELD

The present invention relates to a method and a system for controlling a telerobotic robot using an input device which comprises a movable actuator, and to a computer program or computer program product for carrying out the method.

### BACKGROUND

From company-internal practice, it is known to control a telerobotic robot using an input device which comprises a movable actuator. Target pose changes of the telerobotic robot, for example of its end effector or TCP, are commanded by an operator on the basis of a detected manual adjustment of the actuator and, conversely, target forces of the actuator are commanded on the basis of sensor-determined external forces on the telerobotic robot, so that the operator experiences haptic (force) feedback on the actuator.

### SUMMARY

The object of the present invention is to improve the control of a telerobotic robot by actuation of an actuator of an input device.

This object is achieved by a method, a system, and computer program product for carrying out a method as described herein.

According to one embodiment of the present invention, a method for controlling a telerobotic robot using an input device which comprises a movable actuator, comprises the following steps, which are, cyclically in one embodiment, preferably repeated multiple times:
commanding a target pose of the telerobotic robot, in one embodiment commanding a target pose of a robot-fixed reference of the telerobotic robot, on the basis of a detected position of the actuator, which in one embodiment is manually effected by an operator; and
commanding a target force of the actuator, in particular on the actuator.

By commanding target poses, the telerobotic robot can advantageously be controlled (more) precisely in one embodiment, by commanding target forces in one embodiment, a (more) advantageous, in particular (more) reliable, (more) ergonomic and/or (more) intuitive operation of the actuator is realized and thus in one embodiment teleoperation is simplified and/or its reliability is improved.

In one embodiment, the telerobotic robot comprises a ((telerobotic) robot) arm having at least three, in particular at least six, in one embodiment at least seven, joints or movement axes. In one embodiment, the robot-fixed reference is stationary with respect to a distal end flange of the telerobotic robot (arm); in one embodiment, the robot-fixed reference comprises an end effector or TCP of the telerobotic robot (arm), and can in particular be an end effector or TCP of the telerobotic robot (arm).

In one embodiment, the actuator is spatially separated from the telerobotic robot and/or a (robot) controller of the telerobotic robot. In one embodiment, the input device, in particular an input device controller, is signal-connected to the telerobotic robot and/or a (robot) controller of the telerobotic robot; in a further development it is wired, which can increase security in one embodiment, and in another further development it is wireless, which in one embodiment can increase flexibility and/or range. In one embodiment, the actuator is movably mounted, in particular via one or more joints, on a base of the input device, wherein a position of the actuator relative to the base of the input device is detected in one embodiment, preferably by sensors.

In one embodiment, a pose of the telerobotic robot comprises a one-, two- or three-dimensional position and/or a one-, two- or three-dimensional orientation, in one embodiment a or the robot-fixed reference, in particular an end effector or TCP, of the telerobotic robot. Additionally or alternatively, in one embodiment, a pose of the telerobotic robot comprises the joint position of one or more joints of the telerobotic robot. In one embodiment, a position of the actuator comprises a one-, two- or three-dimensional position and/or a one-, two- or three-dimensional orientation of the actuator relative to a or the base of the input device and/or the joint position of one or more joints, via which the actuator is movably mounted relative to a or the base of the input device.

A force within the meaning of the present invention may also in particular comprise, in particular be, a pair of forces or torque that are parallel in opposite directions. Controlling within the meaning of the present invention may also be regulation.

In one embodiment, drives of the telerobotic robot adjust its axes or joints in order to approach the commanded target pose(s), wherein corresponding target joint adjustments are determined in a manner known per se by means of inverse kinematics in one embodiment, optionally with redundancy resolution in a manner known per se.

In one embodiment, drives of the input device actuate the actuator in order to exert the commanded target force, in particular via the actuator on an operator who manually actuates the actuator.

According to one embodiment of the present invention, one or more virtual borders between (in each case) a permissible and an impermissible region are specified for the telerobotic robot in particular.

The one or more virtual borders are in one embodiment (each) specified as a virtual, in particular straight or curved, wall in a working space of the telerobotic robot.

As a result, in one embodiment, the teleoperation can be improved, in particular an environment of the telerobotic robot can be protected and/or controlling the telerobotic robot by an operator can be improved, in particular guided, using the input device.

In one embodiment, the virtual borders(s) are (each) specified as a virtual stop of one or more joints of the telerobotic robot.

In one embodiment, the telerobotic robot can thereby be protected.

According to one embodiment of the present invention, the commanded target force of the actuator comprises a restoring force component starting from this virtual border, said restoring force component counteracting an actuation of the actuator for commanding a movement of the telerobotic robot away from the border in the direction of the impermissible region or is determined or commanded in such a way.

In one embodiment, this provides the operator who controls the telerobotic robot via the actuator(s) with advantageous haptic feedback in the form of an artificially or additionally generated counterforce. In one embodiment, the control of the telerobotic robot can thereby be improved using the input device or by an operator actuating the actuator, in particular the operator can control the telerobotic robot (more) easily, (more) reliably, (more) precisely, (more) ergonomically and/or (more) intuitively.

In one embodiment, the restoring force component simulates, preferably only or exclusively, contact of the telerobotic robot with an obstacle; in one embodiment, contact of a or the robot-fixed reference of the telerobotic robot with an environmental obstacle. In one embodiment, this means that an operator of the actuator only feels this restoring force component as a force (component) which, scaled in one embodiment, corresponds to an external force on the telerobotic robot, in particular the robot-fixed reference, in a direction that is perpendicular to a (virtual) surface of the (virtual) obstacle and is directed away from this (virtual) surface (in the permissible region), or the target force or restoring force component is determined or commanded accordingly.

In one embodiment, the control of the telerobotic robot can thereby be improved using the input device or by an operator actuating the actuator, in particular the operator can control the telerobotic robot (more) easily, (more) reliably, (more) precisely, (more) ergonomically and/or (more) intuitively.

In one embodiment, the restoring force component is a force of a virtual compression spring, wherein, in a further development, this virtual compression spring is only (virtually) tensioned or compressed by or in the event of an actuation of the actuator for commanding a movement of the telerobotic robot away from the border in the direction of the impermissible region and/or by or in the event of a movement of the telerobotic robot away from the border in the direction of the impermissible region and/or a spring (pressure) force of this virtual compression spring depends on a current and/or previous position of the actuator and/or on a current and/or previous pose of the telerobotic robot, in particular the robot-fixed reference, and is determined in particular on the basis of a current and/or previous position of the actuator and/or a current and/or previous pose of the telerobotic robot, in particular the robot-fixed reference. In one embodiment, this virtual spring thus acts only as a pressure spring and not as a tension spring. In one embodiment, this restoring force component or virtual compression spring only transmits or simulates a force on the telerobotic robot in the opposite direction to a contact or penetration direction which is directed away from the border in the direction of the impermissible region, but not in any other direction, or a corresponding force (component) on the actuator.

In one embodiment, the restoring force component can thereby be determined particularly easily, reliably and/or precisely and/or contact of the telerobotic robot with an obstacle can be simulated particularly easily and/or realistically.

In one embodiment, the spring (pressure) force of the virtual compression spring (also) depends on a specified spring stiffness of the virtual compression spring, which in one embodiment may be set by an operator of the input device, and is determined in particular on the basis of a specified spring stiffness of this virtual spring, which may be set by an operator of the input device.

Additionally or alternatively, in one embodiment, the spring (pressure) force of the virtual compression spring (also) depends on a specified scaling between adjustments of the actuator and movements of the telerobotic robot, in particular the robot-fixed reference, which in one embodiment may be set by an operator of the input device, and is determined in particular on the basis of a specified scaling between adjustments of the actuator and movements of the telerobotic robot, in particular the robot-fixed reference, which in one embodiment may be set by an operator of the input device.

In one embodiment, a particularly advantageous spring characteristic of the virtual spring or contact force component or the simulated contact can thereby be realized and, in one embodiment, teleoperation can be simplified and/or its reliability can be improved.

In one embodiment, commanding a movement of the telerobotic robot starting from the border in the direction of the impermissible region is suppressed during an actuation of the actuator for commanding this movement of the telerobotic robot or, in the event of an actuation of the actuator for commanding a movement of the telerobotic robot, a component of this movement starting from the border in the direction of the impermissible region is hidden or not commanded or only components of this movement are commanded in the direction of the permissible region and/or along the border.

As a result, in one embodiment, the teleoperation can be improved, in particular an environment of the telerobotic robot can be protected and/or controlling the telerobotic robot by an operator can be improved, in particular guided, using the input device.

In one embodiment, the target force comprises a force feedback component which depends on an external force acting on or at the telerobotic robot, in a further development on or at its robot-fixed reference, which emulates said external force in one embodiment and emulates it in a scaled manner in a further development.

In one embodiment, the external force on or at the telerobotic robot is determined by means of at least one distal or end effector-side force sensor of the telerobotic robot and/or, preferably model-based, on the basis of joint forces of the telerobotic robot.

As a result, in one embodiment, advantageous haptic feedback can be realized and the teleoperation can thereby be improved, preferably the operator can control the telerobotic robot (more) easily, (more) reliably, (more) precisely, (more) ergonomically and/or (more) intuitively.

In one embodiment, the desired force comprises a damping component which depends on an adjustment speed of the actuator, which in one embodiment is directed in the opposite direction.

As a result, in one embodiment, the operator can control the telerobotic robot (more) easily, (more) reliably, (more) precisely, and/or (more) ergonomically.

In one embodiment, provided that the telerobotic robot is in the permissible range or not at the border or in the impermissible range, a target force f_{d,HD} of the actuator is determined, which comprises a force feedback component which depends on an external force fₑ of the telerobotic robot, in one embodiment on a or the robot-fixed reference, in particular the end effector or TCP, and in particular emulates said external force (in a scaled manner), and in one embodiment additionally comprises a damping component which depends on a current adjustment speed (dX/dt)_{c,HD} of the actuator:

$${f}_{d , HD} = {f}_{e} - D \cdot {( dX / dt )}_{c , HD} \qquad ( 1 )$$

with the damping coefficient D.

In one embodiment, a target pose X_{d,r} of a or the robot-fixed reference, in particular the end effector or TCP, is determined according to

$${X}_{d , r} = ( {X}_{c , HD} - {X}_{ini , HD} ) \cdot s + {X}_{ini , r} \qquad ( 2 )$$

with the current position X_{c,HD} of the actuator, the previous position X_{ini,HD} of the actuator, the previous pose X_{ini,r} of the telerobotic robot or the robot-fixed reference and a specified scaling s between adjustments of the actuator and movements of the telerobotic robot or the robot-fixed reference provided that the telerobotic robot is in the permissible region or not at the border or in the impermissible region.

In one embodiment, an impermissible or limiting direction u_{L} is determined for one or more virtual borders, preferably perpendicular to the virtual border and in the direction of the impermissible region. If, for example, a virtual border in the form of a virtual wall at yₘₐₓ is specified in the Cartesian working space, this is the impermissible or limiting direction u_{L}=[0 1 0]^{T}.

In one embodiment, a rotation matrix ⁰R_{L} which transforms a coordinate system 0 of Cartesian space and a coordinate system L which is aligned with the impermissible or limiting direction, in one embodiment comprises a z-axis aligned with this, is determined, wherein a rotation axis U and a rotation angle θ of this transformation or rotation matrix are determined in one embodiment from

$$U = {[ 001 ]}^{⊤} \times {u}_{L} \qquad ( 3.1 )$$

$$cos θ = ( {[ 001 ]}^{T} \cdot {u}_{L} ) / ‖ {u}_{L} ‖ \qquad ( 3.2 )$$

and the rotation matrix ⁰R_{L} is transformed from the coordinate system L into the coordinate system 0, its transpose (⁰R_{L})^{T} correspondingly from the coordinate system 0 into the coordinate system L. Of course, another axis can be used instead of the z-axis and this can be taken into account in the corresponding equations.

Starting from the virtual border, in one embodiment, a restoring force component

$${}^{L} {e}_{HD} = {( {}^{O} {R}_{L} )}^{⊤} \cdot ( {X}_{d , HD} - {X}_{c , HD} ) \qquad ( 4.1 )$$

$${}^{L} {f}_{imp , HD} = O \qquad ( 4.2 )$$

$${}^{L} {e}_{HD} [ 3 ] < 0 ⇒ set {}^{L} {f}_{imp , HD} [ 3 ] = K \cdot {}^{L} {e}_{HD} [ 3 ] \qquad ( 4.3 )$$

$${f}_{imp , HD} = {}^{O} {R}_{L} \cdot {}^{L} {f}_{imp , HD} \qquad ( 4.4 )$$

of a virtual compression spring is added:

$${f}_{d , HD} = {f}_{e} + {f}_{imp , HD} - D \cdot {( dX / dt )}_{c , HD} \qquad ( 5 )$$

to the target force f_{d,HD} of the actuator according to equation (1). Here, K is a spring stiffness of the virtual spring and X_{d, HD} is a target position of the actuator, in particular according to:

$${X}_{d , HD} = ( {X}_{c , r} - {X}_{ini , r} ) / s + {X}_{ini , HD} \qquad ( 6 )$$

with the current Pose X_{c,r} of the robot-fixed reference. It can be seen that the spring force of the virtual compression spring depends on the current and previous position of the actuator and the current and previous pose of the telerobotic robot:

$$K \cdot ( {X}_{d , HD} - {X}_{c , HD} ) = K \cdot [ ( {X}_{c , r -} {X}_{ini , r )} / s + ( {X}_{ini , HD -} {X}_{c , HD} ) ] \qquad ( 7 )$$

and only counteracts an actuation of the actuator for commanding a movement of the telerobotic robot away from the border in the direction of the impermissible region (^{L}e_{HD} [3]<0). The index *[3] denotes the z component of the corresponding vector.

If, for example, a virtual border in the form of a virtual wall is specified in the working space at yₘₐₓ, starting from the border, i.e. for y_{d,r}>yₘₐₓ with the y component y_{d,r} of the Cartesian position of the end effector or TCP, commanding a movement of the telerobotic robot in the direction of the impermissible region is suppressed during an actuation of the actuator for commanding this movement of the telerobotic robot

$${γ}_{d , r} > {γ}_{max} ⇒ set {y}_{d , r} = {y}_{max} \qquad ( 8 )$$

and the restoring force component

$${f}_{imp , HD} = K \cdot {[ 0 ( {y}_{d , HD} - {y}_{c , HD} ) 0 ]}^{⊤} \qquad ( 9.1 )$$

or in general form

$${f}_{imp , HD} = K \cdot ( {X}_{d , HD} - {X}_{c , HD} ) \qquad ( 9.2 )$$

is added to the target force f_{d,HD} of the actuator according to equation (1).

If a virtual border is specified as a virtual stop of one or more joints, in one embodiment in a one-matrix, the rows or columns of the joints which are at the stop or the virtual border are assigned zero, for example in a telerobotic robot with seven joints and the second and sixth joints at the virtual stop:

$$P = [ \begin{matrix}1 & 0 & 0 & 0 & 0 & 0 & 0 \\ 0 & 0 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 0 & 0 \\ 0 & 0 & 0 & 0 & 0 & 0 & 1\end{matrix} ] \qquad ( 10 )$$

and a singular value decomposition (SVD) of the matrix J·P·(J·P)^{T} with the Jacobian matrix J of the robot-fixed reference into an unitary matrix U, the adjoint V* of a unitary matrix V and the matrix S of the singular values is carried out (U·S·V*=J·P·(J·P)^{T}). For the singular values equal to zero, i.e., the values S[m, m] of the matrix S that are equal to zero, an impermissible or limiting direction is determined by the associated column vector U[:, m] of the matrix U. The index *[m,m] denotes the value in column m and row m of the corresponding matrix, the index *[:,m] denotes the mth column vector.

In addition, a speed direction according to

$${dX}_{e} / dt = J \cdot ( 1 - P ) \cdot {J}^{\#} \cdot {( dX / dt )}_{d , r} \qquad ( 11.1 )$$

$${u}_{vel} = {dX}_{e} / dt / ‖ {dX}_{e} / dt ‖ \qquad ( 11.2 )$$

with the pseudo-inverse J^{#} and the Cartesian target speed to achieve the desired pose is determined under the assumption that no joint stops are present, and the (corresponding) angle θ between this speed direction and the corresponding column vector(s0 U[:, m] of the matrix U is determined:

$$cos θ = ( {u}_{vel} \cdot U [ : , m ] ) / ‖ U [ : , m ] ‖ \qquad ( 12 )$$

If this angle is greater than 90°, the negative (normalized) column vector(s) U[:, m] of the matrix U are used as the impermissible or limiting direction u_{L}, otherwise the (normalized) column vector(s) U[:, m] of the matrix U are used:

$${U}_{L} = \{ \begin{matrix}U [ : , m ] , if θ \leq 90 ° \\ - U [ : , m ] , otherwise\end{matrix} \qquad ( 13 )$$

This impermissible or limiting direction u_{L} is then used in the manner described above in order to determine or command the associated restoring force component in the case of a virtual border in the form of a virtual stop of one or more joints of the telerobotic robot.

According to one embodiment of the present invention, a system, in particular in terms of hardware and/or software, in particular in terms of programming, is configured to perform a method described herein and/or comprises:
means for specifying at least one virtual border between a permissible and an impermissible region for the telerobotic robot;
means for commanding a target pose of the telerobotic robot on the basis of a detected position of the actuator; and
means for commanding a target force of the actuator,
wherein the target force comprises a restoring force component starting from the virtual border, said restoring force component counteracting an actuation of the actuator for commanding a movement of the telerobotic robot away from the border in the direction of the impermissible region.

In one embodiment, the system or its means comprises:

Means for suppressing commanding a movement of the telerobotic robot starting from the border in the direction of the impermissible region during an actuation of the actuator for commanding this movement of the telerobotic robot.

A system and/or a means within the meaning of the present invention may be designed in hardware and/or in software, and in particular may comprise at least one data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to control the telerobotic robot. In one embodiment, a computer program product may comprise, in particular, a storage medium, in particular a computer-readable and/or non-volatile storage medium for storing a program or instructions or with a program or with instructions stored thereon. In one embodiment, executing this program or these instructions by a system or a controller, in particular a computer or an arrangement of a plurality of computers, causes the system or the controller, in particular the computer(s), to carry out a method described here or one or more of its steps, or the program or the instructions are configured for this purpose.

In one embodiment, one or more, in particular all, steps of the method are performed completely or partially automatically, in particular by the system or its means.

In one embodiment, the system comprises the telerobotic robot and/or its robot controller and/or the input device.

Contact within the meaning of the present invention is understood in particular as single-sided contact or contact of two surfaces in a manner known per se.

In one embodiment, the target pose, in a further development commanding and/or approaching the target pose, is realized by means of a position, speed or force control in the joint space or space of the joint coordinates of the telerobotic robot. In one embodiment, the telerobotic robot can thereby advantageously be operated, in particular (more) precisely, (more) easily and/or (more) reliably.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically illustrates a system for controlling a telerobotic robot using an input device according to an embodiment of the present invention; and

FIG. 2 is a flowchart illustrating a method for controlling the telerobotic robot using the input device according to an embodiment of the present invention.

### DETAILED DESCRIPTION

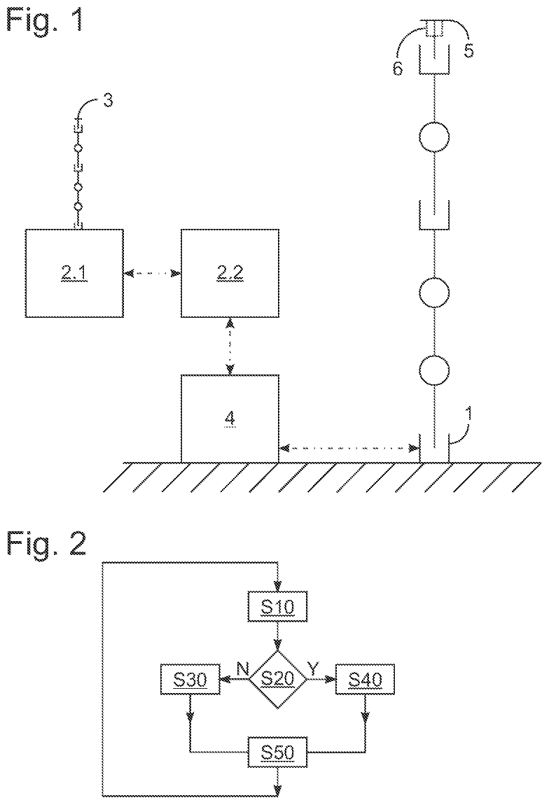

FIGS. 1 and 2 show a system or method according to an embodiment of the present invention for controlling a telerobotic robot (arm) 1 using an input device, which comprises a base 2.1, an actuator 3 movable relative to the base 2.1, and an input device controller 2.2, via a robot controller 4, which communicates wirelessly or via wire with the input device controller 2.2. The input device controller 2.2 can be integrated into the base 2.1.

In one step S10, a current pose of the actuator 3 relative to the input device 2.1 and an external force fₑ at a robot-fixed reference in the form of an end effector 5 are determined using sensors, in one embodiment by means of at least one distal or end effector-side force sensor 6 of the telerobotic robot (arm) or model-based on the basis of joint forces of the telerobotic robot (arm). In addition, a current position X_{c,HD} of the actuator and a current pose X_{c,r} of the end effector 5 are determined, wherein the (current) adjustment speed (dX/dt)_{c,HD} is determined in one embodiment by time differentiation of the current position X_{c,HD} or, conversely, the current position X_{c,HD} is determined by time integration.

In one step S20, it is determined whether the telerobotic robot is located at one or more specified virtual borders or impermissible regions delimited thereby.

If this is not the case (S20: “N”), a new target force f_{d,HD} of the actuator 3 and a new target pose X_{d,r} of the telerobotic robot, in one embodiment of the end effector 5, are determined in one step S30 according to the above equations (1), (2).

Otherwise (S20: “Y”), in one step S34 according to the above equations (2)-(13), a new target force f_{d,HD} of the actuator 3 and a new target pose X_{d,r} of the telerobotic robot, in one embodiment of the end effector 5, are determined, in particular commanding a movement of the telerobotic robot during an actuation of the actuator for commanding this movement of the telerobotic robot (cf. equation (8)) is suppressed and the target force is determined with the corresponding restoring force component(s) (cf. equation (5)), so that an operator of or on the actuator 3 feels the telerobotic robot come into contact with a virtual obstacle.

In one step S50, the corresponding target pose and target force are commanded.

The method then returns to step S10, wherein the previous current position of the actuator 3 forms the new previous position of the actuator 3 and the previous current pose of the end effector 5 forms the new previous pose of the end effector 5.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Telerobotic robot (arm)
2.1 Input device base
2.2 Input device controller
3 Actuator
4 Robot controller
5 End effector (robot-fixed reference)
6 Force sensor

What is claimed is:

1. A method for controlling a telerobotic robot (1) using an input device which comprises a movable actuator (3), having the following steps, which are repeated multiple times in particular:
commanding (S50) a target pose of the telerobotic robot on the basis of a detected position of the actuator; and
commanding (S50) a target force of the actuator;
wherein at least one virtual border is specified between a permissible and an impermissible region for the telerobotic robot, and the target force comprises a restoring force component starting from said border, said restoring force component counteracting an actuation of the actuator for commanding a movement of the telerobotic robot away from the border in the direction of the impermissible region.

2. The method according to claim 1, characterized in that the restoring force component simulates contact of the telerobotic robot with an obstacle.

3. The method according to any of the preceding claims, characterized in that the restoring force component is a force of a virtual compression spring, in particular a virtual compression spring which is only tensioned by a movement of the telerobotic robot away from the border in the direction of the impermissible region and/or an actuation of the actuator for commanding a movement of the telerobotic robot away from the border in the direction of the impermissible region and/or the spring force of which depends on a current and/or previous position of the actuator and/or on a current and/or previous pose of the telerobotic robot and/or on a specified spring stiffness of the virtual compression spring and/or on a specified scaling between adjustments of the actuator and movements of the telerobotic robot.

4. The method according to any of the preceding claims, characterized in that commanding a movement of the telerobotic robot starting from the border in the direction of the impermissible region is suppressed during an actuation of the actuator for commanding this movement of the telerobotic robot.

5. The method according to any of the preceding claims, characterized in that the virtual border is specified as a virtual wall in a working space of the telerobotic robot or as a virtual stop of at least one joint of the telerobotic robot.

6. The method according to any of the preceding claims, characterized in that the target force comprises a force feedback component which depends on an external force on the telerobotic robot, and in particular emulates said external force, if necessary in a scaled manner.

7. The method according to any of the preceding claims, characterized in that the target force comprises a damping component which depends on an adjustment speed of the actuator.

8. A system for controlling a telerobotic robot (1) using an input device which comprises a movable actuator (3) which is set up to carry out a method according to any of the preceding claims and/or comprises:
means for specifying at least one virtual border between a permissible and an impermissible region for the telerobotic robot;
means for commanding a target pose of the telerobotic robot on the basis of a detected position of the actuator; and
means for commanding a target force of the actuator,
wherein the target force comprises a restoring force component starting from the virtual border, said restoring force component counteracting an actuation of the actuator for commanding a movement of the telerobotic robot away from the border in the direction of the impermissible region.

9. A computer program or computer program product, wherein the computer program or computer program product contains instructions, in particular stored on a computer-readable and/or non-volatile storage medium, which instructions, when executed by one or more computers or a system according to claim 8, cause the computer(s) or the system to carry out a method according to any of claims 1 to 7.
